(19) United States
(12) Patent Application Publication
(10) Pub. No.: US 2009/0296001 A1
(43) Pub. Date: Dec. 3, 2009

(54) INTEGRATED CIRCUIT BOARD HAVING TV BOX CIRCUIT AND WIRELESS NETWORK CARD CIRCUIT

(76) Inventor: Chun-Kai CHAN, Taipei (TW)

Correspondence Address: BIRCH STEWART KOLASCH & BIRCH, PO BOX 747, FALLS CHURCH, VA, 22040-0747, US

(21) Appl. No.: 12/465,785

(22) Filed: May 14, 2009

(30) Foreign Application Priority Data
May 30, 2008 (TW) 097120260

(51) Int. Cl. H04N 5/44

(52) U.S. Cl. 348/725; 348/E05.096

(57) ABSTRACT

An integrated circuit board includes a TV box circuit, a wireless network card circuit and a hub chip. The TV box circuit receives a TV signal. The wireless network card circuit receives or transmits a wireless communication signal. The hub chip is electrically connected to the TV box circuit and the wireless network card circuit for processing the TV signal and the wireless communication signal and transmitting the processed TV signal and the processed wireless communication signal to an electronic device.

### FIELD OF THE INVENTION

The present invention relates to an integrated circuit board, and more particularly to an integrated circuit board having a TV box circuit and a wireless network card circuit. The present invention also relates to an electronic device having such an integrated circuit board.

### BACKGROUND OF THE INVENTION

With increasing development of digitalized technologies, a variety of digital products are designed in views of convenience and user-friendliness. Nowadays, many external peripheral devices are used with personal computers due to the amazing power of the personal computers. The common external peripheral devices include for example wireless TV tuner cards, TV boxed, digital TV sticks, 3G wireless network cards, 3.5G wireless network cards, and the like. By means of TV tuner cards, TV boxes or digital TV sticks, digital or analog television programs may be displayed on the computer screens according to a wired transmission technology or a wireless transmission technology. By means of 3G wireless network cards or 3.5G wireless network cards, the computer systems can communicate with other communication devices over the wireless communication network.

Conventionally, the external peripheral device is connected to the connecting port, the interface card slot or the IRQ interface component of the computer system. Nowadays, the external peripheral device is connected to computer system through a universal serial bus (USB) interface, an IEEE 1394 interface, a Device Bay interface or the like.

Recently, the computer system is developed to meet a so-called “plug and play” requirement in order to increase convenience and operating efficiency of the computer system. Among the above transmission interfaces, the USB interface is widely utilized to meeting the “plug and play” requirement. That is, during operation of the computer system, an USB external peripheral device can be communicated with the computer system through the USB interface in hot-plugging and unplugging manners.

Generally, the external peripheral device to be communicated with the computer host has a specified function. For executing many functions by the computer system, diverse external peripheral devices need to be communicated with the computer system through respective connecting ports. As known, it is not cost-effective to simultaneously purchase too many external peripheral devices. In addition, the volume and the overall weight become hindrance from simultaneously carrying many external peripheral devices. Since the number of connecting ports of the computer system is finite, only finite number of external peripheral devices may be simultaneously inserted into respective connecting ports of the computer host.

### SUMMARY OF THE INVENTION

The present invention relates to an integrated circuit board having a TV box circuit and a wireless network card circuit.

The present invention also relates to an electronic device having such an integrated circuit board.

In accordance with an aspect of the present invention, there is provided an integrated circuit board for use with an electronic device. The integrated circuit board includes a TV box circuit, a wireless network card circuit and a hub chip. The TV box circuit receives a TV signal. The wireless network card circuit receives or transmits a wireless communication signal. The hub chip is electrically connected to the TV box circuit and the wireless network card circuit for processing the TV signal and the wireless communication signal and transmitting the processed TV signal and the processed wireless communication signal to the electronic device.

In accordance with another aspect of the present invention, there is provided an electronic device. The electronic device includes a motherboard and an integrated circuit board. The integrated circuit board includes a TV box circuit, a wireless network card circuit and a hub chip. The TV box circuit receives a TV signal. The wireless network card circuit receives or transmits a wireless communication signal. The hub chip is electrically connected to the TV box circuit and the wireless network card circuit for processing the TV signal and the wireless communication signal and transmitting the processed TV signal and the processed wireless communication signal to the motherboard.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating an integrated circuit board according to a preferred embodiment of the present invention;

FIG. 2 is a schematic functional block diagram illustrating the integrated circuit board used as a built-in peripheral device of an electronic device; and

FIG. 3 is a schematic functional block diagram illustrating the integrated circuit board used as an external peripheral device of an electronic device.

### DETAILED DESCRIPTION OF THE PREFERRED EMBODIMENT

The present invention will now be described more -specifically with reference to the following embodiments. It is to be noted that the following descriptions of preferred embodiments of this invention are presented herein for purpose of illustration and description only. It is not intended to be exhaustive or to be limited to the precise form disclosed.

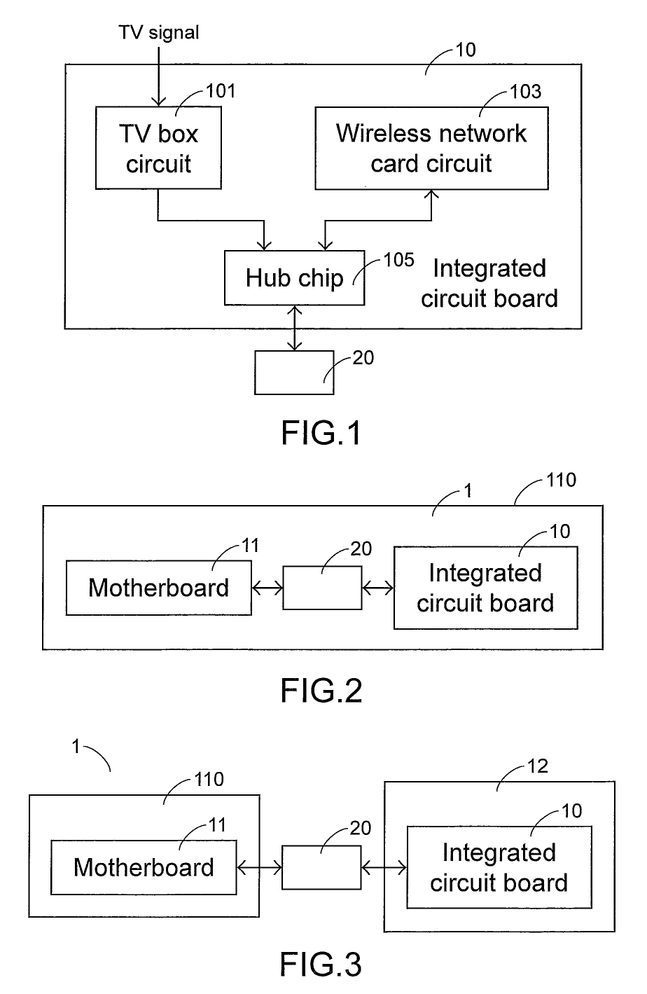

FIG. 1 is a schematic functional block diagram illustrating an integrated circuit board according to a preferred embodiment of the present invention. As shown in FIG. 1, a TV box circuit 101, a wireless network card circuit 103 and a hub chip 105 are arranged on the integrated circuit board 10. The TV box circuit 101 and the wireless network card circuit 103 are electrically connected to the hub chip 105. In addition, a transmission terminal 20 is also disposed on the circuit board 10. Through the transmission terminal 20, the circuit board 10 can be communicated with a motherboard of an electronic device.

The TV box circuit 101 is for example a cable TV box circuit or a wireless TV box circuit. In a case that the TV box circuit 101 is a cable TV box circuit, the TV signals issued by a cable TV source can be received by the TV box circuit 101 through a coaxial cable (not shown). Whereas, in a case that the TV box circuit 101 is a wireless TV box circuit, the TV signals issued by a wireless television source can be received by the TV box circuit 101 through an antenna (not shown). The TV signals are analog signals or digital signals. According to the signal types, the TV box circuit 101 can be a digital TV box circuit or an analog TV box circuit.

The wireless network card circuit 103 is for example a 3G wireless network card circuit or a 3.5G wireless network card circuit or receiving or transmitting wireless communication signals according to a wireless transmission technology.

The TV signals received by the TV box circuit 101 and the wireless communication signals received by the wireless network card circuit 103 are transmitted to the hub chip 105. After the TV signals and the wireless communication signals are processed by the hub chip 105, processed TV signals and processed wireless communication signals are respectively outputted from the hub chip 105.

An exemplary transmission terminal 20 includes but is not limited to a USB transmission terminal, an edge connector (or a gold finger) and the like. The transmission terminal 20 is also connected to the hub chip 105 for receiving the processed TV signals and the processed wireless communication signals that are outputted from the hub chip 105. After the integrated circuit board 10 is electrically connected with a motherboard 11 of an electronic device 1 (as shown in FIG. 2 and FIG. 3) through the transmission terminal 20, the processed TV signals and the processed wireless communication signals can be transmitted to the motherboard 11 of the electronic device 1 through the transmission terminal 20. Moreover, after the integrated circuit board 10 is electrically connected with the motherboard 11, electricity and output communication signals can be transmitted from the electronic device 1 to the hub chip 105 of the integrated circuit board 10 through the transmission terminal 20. After the output communication signals are processed by the hub chip 105, the processed output communication signals are transmitted to the wireless network card circuit 103 to be outputted.

FIG. 2 is a schematic functional block diagram illustrating the integrated circuit board used as a built-in peripheral device of an electronic device. As shown in FIG. 2, the electronic device 1 has a motherboard 11 and an integrated circuit board 10. The motherboard 11 and the integrated circuit board 10 are disposed within a casing 110. The integrated circuit board 10 is electrically connected with the motherboard 11 through a transmission terminal 20 of the integrated circuit board 10.

FIG. 3 is a schematic functional block diagram illustrating the integrated circuit board used as an external peripheral device of an electronic device. As shown in FIG. 3, the electronic device 1 has a casing 110 and a motherboard 11. The motherboard 11 is disposed within the casing 110. The integrated circuit board 10 is disposed within a mini-card type casing (or an external enclosure) 12. In this circumstance, the transmission terminal 20 is disposed on the casing 12.

From the above description, since the integrated circuit board of the present invention has a TV box circuit and a wireless network card circuit, the integrated circuit board has dual functions of a TV box and a wireless network card. The integrated circuit board can be used as a built-in peripheral device or an external peripheral device of an electronic device. An example of the electronic device is a computer.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An integrated circuit board for use with an electronic device, the integrated circuit board comprising:
a TV box circuit for receiving a TV signal;
a wireless network card circuit for receiving or transmitting a wireless communication signal; and
a hub chip electrically connected to the TV box circuit and the wireless network card circuit for processing the TV signal and the wireless communication signal and transmitting the processed TV signal and the processed wireless communication signal to the electronic device.

2. The integrated circuit board according to claim 1 wherein the hub chip of the integrated circuit board is electrically connected with the electronic device through a transmission terminal, so that the processed TV signal and the processed wireless communication signal are transmitted to the electronic device through the transmission terminal.

3. The integrated circuit board according to claim 2 wherein the transmission terminal is an edge connector.

4. The integrated circuit board according to claim 2 wherein the transmission terminal is USB transmission terminal.

5. The integrated circuit board according to claim 1 wherein the wireless network card circuit is a 3G wireless network card circuit or a 3.5G wireless network card circuit.

6. The integrated circuit board according to claim 1 wherein the TV box circuit is a digital TV box circuit or an analog TV box circuit.

7. An electronic device comprising:
a motherboard; and
an integrated circuit board comprising:
a TV box circuit for receiving a TV signal;
a wireless network card circuit for receiving or transmitting a wireless communication signal; and
a hub chip electrically connected to the TV box circuit and the wireless network card circuit for processing the TV signal and the wireless communication signal and transmitting the processed TV signal and the processed wireless communication signal to the motherboard.

8. The electronic device according to claim 7 further comprising a transmission terminal connected to the hub chip, wherein the processed TV signal and the processed wireless communication signal are transmitted to the motherboard through the transmission terminal.

9. The electronic device according to claim 8 wherein the transmission terminal is an edge connector.

10. The electronic device according to claim 8 wherein the transmission terminal is USB transmission terminal.

11. The electronic device according to claim 7 wherein the wireless network card circuit is a 3G wireless network card circuit or a 3.5G wireless network card circuit.

12. The electronic device according to claim 7 wherein the TV box circuit is a digital TV box circuit or an analog TV box circuit.
